(19) United States
(12) Patent Application Publication
(10) Pub. No.: US 2013/0076181 A1
(43) Pub. Date: Mar. 28, 2013

(54) BASE ASSEMBLY FOR MOTOR AND MOTOR INCLUDING THE SAME

(71) Applicants: Ta Kyoung LEE, Hwaseong (KR); Sang Jin PARK, Hwaseong (KR)

(72) Inventors: Ta Kyoung LEE, Hwaseong (KR); Sang Jin PARK, Hwaseong (KR)

(73) Assignee: SAMSUNG ELECTRO-MECHANICS CO., LTD., Suwon (KR)

(21) Appl. No.: 13/331,286

(22) Filed: Dec. 20, 2011

(30) Foreign Application Priority Data
Sep. 22, 2011 (KR) 10-2011-0095654

(51) Int. Cl. H02K 5/00

(52) U.S. Cl. 310/91

(57) ABSTRACT

There are provided a base assembly for a motor having improved noise and vibrations generating prevention characteristics by reducing a cogging torque generated by a stator core, and a motor including the same. The base assembly includes: a base member having a shaft system of the motor, disposed therein; a stator core mounted on the base member, provided to correspond to a magnet provided in a rotating member of the motor, and having a coil wound therearound, the coil generating electromagnetic force; and a dummy core coupled to the base member so as to be positioned on a lower portion of the stator core to thereby reduce cogging torque.

### CROSS-REFERENCE TO RELATED APPLICATIONS

This application claims the priority of Korean Patent Application No. 10-2011-0095654 filed on Sep. 22, 2011, in the Korean Intellectual Property Office, the disclosure of which is incorporated herein by reference.

### BACKGROUND OF THE INVENTION

1. Field of the Invention

The present invention relates to a base assembly for a motor and a motor including the same, and more particularly, to a base assembly for a motor having improved noise and vibration generating prevention characteristics by reducing cogging torque generated by a stator core, and a motor including the same.

2. Description of the Related Art

A hard disk drive (HDD), an information storage device, reads data stored on a disk or writes data to a disk using a read/write head.

The hard disk drive requires a disk driving device capable of driving the disk. As the disk driving device, a small-sized spindle motor is used.

In the small-sized spindle motor, a fluid dynamic pressure bearing is used. The fluid dynamic pressure bearing refers to a bearing in which a shaft, a rotating member, and a sleeve, a fixed member, have oil interposed therebetween, such that the shaft is supported by fluid pressure generated in the oil.

The hard disk drive (HDD) using this fluid dynamic pressure bearing has been used in various portable products such as a netbook computer, a cellular phone, a portable multimedia player (PMP), a game machine, a MP3 player, and the like. Interest in the necessity of the miniaturization and thinning of the hard disk drive has been increased in consideration of the portable products.

In addition, as cases in which users carry the hard disk drive (HDD) using the fluid dynamic pressure bearing increase, whether or not noise and vibrations are generated in the spindle motor using the fluid dynamic pressure bearing has become a significant issue.

Noise and vibrations may be generated due to shaking, or the like, of a core around which a coil is wound. The shaking, or the like, of the core is closely associated with parallelism of the core and adhesion between the core and base.

In addition, noise and the vibrations may also be generated due to cogging torque generated because of a change in attractive force between a magnet and the core, according to the rotation of a rotating member.

Particularly, noise and the vibrations due to cogging torque may be generated by a dispostion relationship of the stator core and the magnet, necessarily provided in order to rotate the motor. However, as interest in noise and vibration problems has increased in accordance with the development of technology, research into a configuration for minimizing noise and vibrations has been urgently demanded.

### SUMMARY OF THE INVENTION

An aspect of the present invention provides a stator core capable of minimizing noise and vibrations due to cogging torque at the time of the rotation of a rotating member, and a motor including the same.

According to an aspect of the present invention, there is provided a base assembly for a motor, the base assembly including: a base member having a shaft system of the motor, disposed therein; a stator core mounted on the base member, provided to correspond to a magnet provided in a rotating member of the motor, and having a coil wound therearound, the coil generating electromagnetic force; and a dummy core coupled to the base member so as to be positioned on a lower portion of the stator core to thereby reduce cogging torque.

The dummy core may have a ring shape.

The dummy core may have an outer diameter disposed to be parallel with an outer diameter of the stator core.

The dummy core may be formed such that an upper edge thereof in an axial direction is disposed upwardly to face the magnet.

The dummy core may be formed of a metallic material.

The base assembly may further include a spacing sheet interposed between the dummy core and the stator core.

The spacing sheet may have a continuous ring shape.

The spacing sheet may be interposed between each of front edge parts of the stator core and the dummy core.

According to another aspect of the present invention, there is provided a motor comprising the base assembly as described above.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a stator core according to an embodiment of the present invention;

FIG. 2 is a schematic exploded perspective view showing a coupling relationship between the stator core according to the embodiment of the present invention, a dummy core, and a base;

FIG. 3 is a schematic cut-away perspective view showing a shape after the stator core according to the embodiment of the present invention, the dummy core, and the base are coupled to one another;

FIG. 4 is a schematic cut-away perspective view showing a disposition relationship between the stator core according to the embodiment of the present invention, the dummy core, and a magnet;

FIG. 5 is a schematic cross-sectional view showing a motor including a stator core according to another embodiment of the present invention;

FIG. 6 is a schematic exploded perspective view showing a coupling relationship between a stator core according to another embodiment of the present invention, a dummy core, and a base; and

FIG. 7 is a schematic exploded perspective view showing a coupling relationship between a stator core according to another embodiment of the present invention, a dummy core, and a base.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

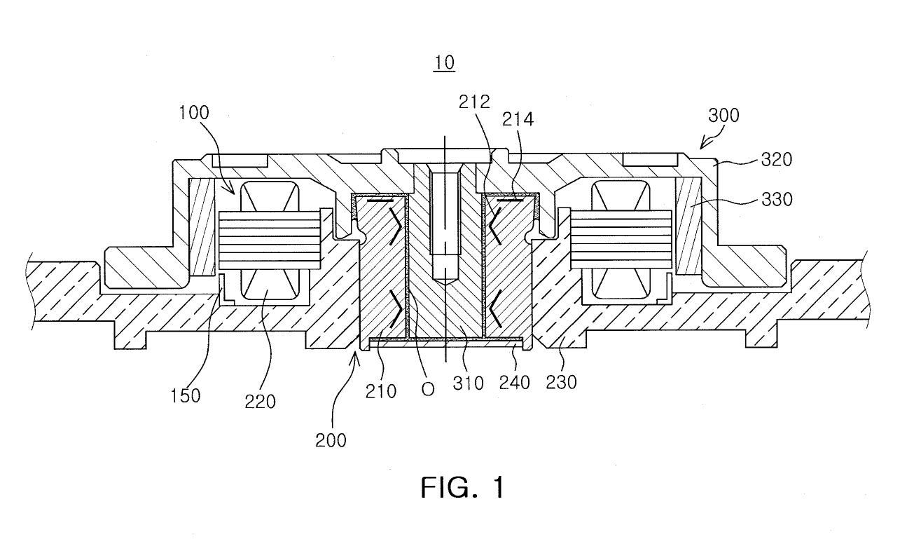

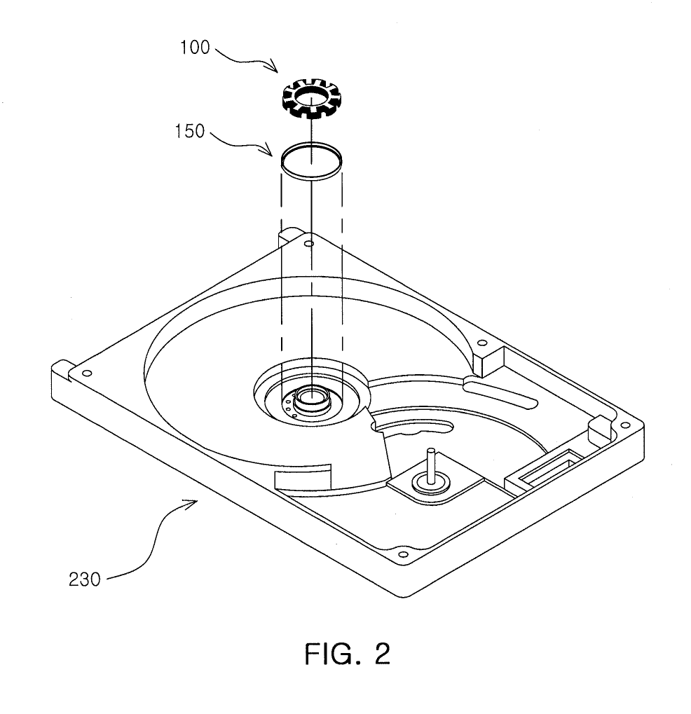

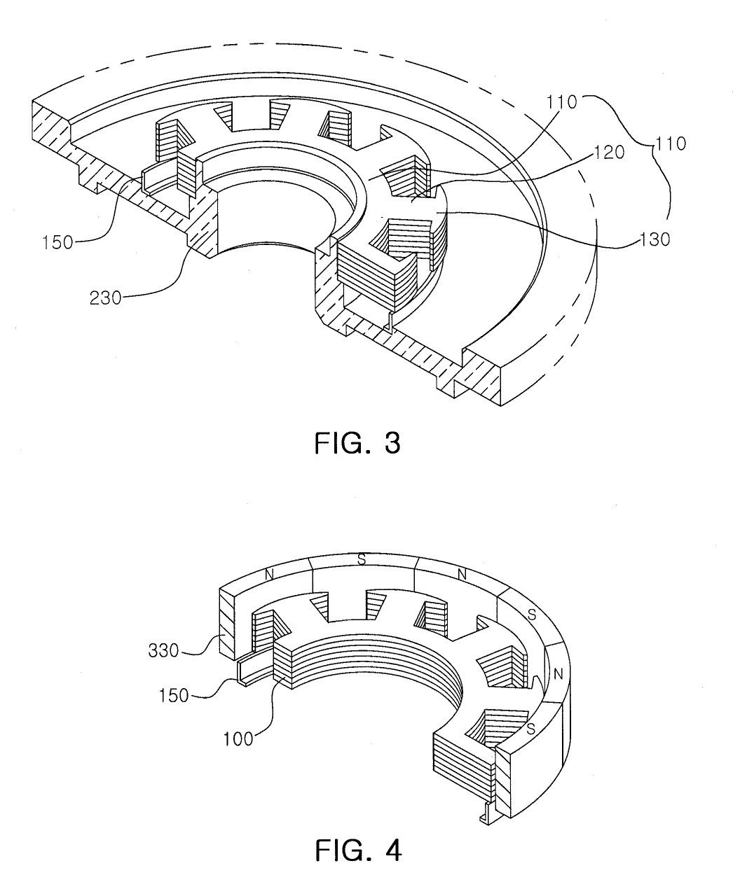

FIG. 1 is a schematic cross-sectional view showing a motor including a stator core according to an embodiment of the present invention. FIG. 2 is a schematic exploded perspective view showing a coupling relationship between the stator core according to the embodiment of the present invention, a dummy core, and a base. FIG. 3 is a schematic cut-away perspective view showing a shape after the stator core according to the embodiment of the present invention, the dummy core, and the base are coupled to one another.

Referring to FIGS. 1 through 3, the motor 10 according to the embodiment of the present invention may include a fixed member 200 having a stator core 100 coupled thereto and a rotating member 300 rotatably supported with respect to the fixed member 200.

Terms with respect to directions will be first defined. As viewed in FIG. 1, an axial direction refers to a vertical direction based on a shaft 310, and an outer diameter or inner diameter direction refers to a direction towards an outer edge of a hub 320 based on the shaft 310 or a direction towards the center of the shaft 310 based on the outer edge of the hub 320.

In addition, a circumferential direction refers to a direction in which the shaft 310 rotates, along an outer peripheral surface thereof.

The fixed member 200 refers to all components, except for the rotating member 300, in the motor 10 according to the embodiment of the present invention. More specifically, the fixed member 200 may include a sleeve 210 supporting the shaft 310, the stator core 100 having a coil 220 wound around, a base 230, and a dummy core 150.

The sleeve 210, a component supporting the shaft 310 which is a component of the rotating member 300, may support the shaft 310 such that an upper end of the shaft 310 protrudes upwardly in the axial direction, and may be formed by forging copper (Cu) or aluminum (Al) or sintering a copper-iron (Cu—Fe)-based alloy powder or a stainless steel (SUS)-based power.

In addition, the sleeve 210 may include a shaft hole having the shaft 310 inserted thereinto so as to have a micro clearance therebetween, the micro clearance being filled with oil O, such that the shaft 310 may be stably supported by radial dynamic pressure due to the oil O.

Here, the radial dynamic pressure due to the oil O may be generated by a fluid dynamic pressure part 212 formed as a groove in an inner peripheral surface of the sleeve 210. The fluid dynamic pressure part 212 may have one of a herringbone shape, a spiral shape and a helical shape.

However, the fluid dynamic pressure part 212 is not limited to being formed in the inner peripheral surface of the sleeve 210 as described above but may also be formed in the outer peripheral surface of the shaft 310, a component of the rotating member 300. In addition, the number of fluid dynamic pressure parts 212 is also not limited.

In addition, the sleeve 210 may include a thrust dynamic pressure part 214 formed in an upper surface thereof so as to generate thrust dynamic pressure due to the oil O. The rotating member 300 including the shaft 310 may rotate while having a predetermined floating force secured by the thrust dynamic pressure part 214.

Here, the thrust dynamic pressure part 214 may be a groove having a herringbone shape, a spiral shape, or a helical shape, similar to the fluid dynamic pressure part 212. However, the thrust dynamic pressure part 214 is not limited to having the above-mentioned shapes, but may have any shape, as long as it may provide the thrust dynamic pressure.

In addition, the thrust dynamic pressure part 214 is not limited to being formed in the upper surface of the sleeve 210 but may also be formed in a surface of the hub 320 corresponding to the upper surface of the sleeve 210.

Further, the sleeve 210 may include a base cover 240 coupled to a lower portion thereof so as to close the lower portion thereof. Through the base cover 240, the motor 10 according to the embodiment of the present invention may be formed to have a full-fill structure.

The stator core 100 may include the coil 220 wound therearound and be mounted on the base 230, which is a corresponding component, the coil 220 having power applied from the outside thereto.

More specifically, the stator core 100 may include a core back 110 coupled to the base 230, the component corresponding thereto, a plurality of teeth parts 120, and front edge parts 130 (See FIGS. 3 and 4).

Here, the teeth parts 120 may be portions around which the coil 220 is wound, and the front edge parts 130 may define as outer edges of the teeth parts 120 in a radial direction thereof.

According to the embodiment of the present invention, the stator core 100 includes the front edge parts 130 provided to the teeth part 120 protruding outwardly from the core back 110 in order to rotate the rotating member through interaction with the magnet 330. The front edge parts 130 have an approximately round shape. However, relative distances between each of the front edge parts 130 and the magnet 330 are different and the number of the front edge parts 130 and the number of magnetic poles of the magnet 330 are different to allow for the generation of a difference in mutual magnetic force between the magnet 330 and the front edge parts 130, such that the rotating member rotates.

However, the front edge parts 130, which are outermost portions of the stator core 100, may not have a continuous ring shape to generate cogging torque with the magnet 330, such that noise and vibrations are inevitably generated.

Hereinafter, noise or vibrations will be collectively referred to as noise and the term ‘noise’ will be interpreted to include the concept of vibrations.

In the motor 10, according to the embodiment of the present invention, the above-mentioned noise may be divided into mechanical noise and electromagnetic noise.

More specifically, the mechanical noise may be structural noise generated due to a coupling relationship between the base 230 and the stator core 100, and the electromagnetic noise may be noise due to cogging torque generated between the stator core 100 and the magnet 330.

First, mechanical noise may be generated when the stator core 100 is eccentric with respect to the center of the axis due to external impacts, or the like, and may also be generated due to shaking, or the like, of the core 100, generated because of weakening of adhesion between the core 100 and the base 230.

The present invention is intended to reduce noise due to cogging torque, rather than mechanical noise.

The core 100 and electromagnetic noise will be described in detail below with reference to FIG. 4.

The base 230 may be the fixed member 200 supporting the rotation of the rotating member 300 including the shaft 310 and the hub 320 with respect to the rotating member 300.

Here, the base 230 may include the above-mentioned stator core 100 coupled thereto, the stator core 100 having the coil 220 wound therearound.

In other words, an outer peripheral surface of the sleeve 210 and the stator core 100 around which the coil 220 is wound are inserted into the base 230, such that the sleeve 210 and the core 100 may be coupled thereto.

The dummy core 150 may be mounted on the base 230 to reduce the cogging torque.

The dummy core 150 may be coupled to the base member so as to be positioned on a lower portion of the stator core 100. More specifically, the dummy core 150 may be positioned on an upper portion or a lower portion of the front edge parts 130 forming the outermost portion of the stator core 100. Further, the dummy core 150 may have an outer diameter disposed to be parallel with an outer diameter of the stator core 100, and more specifically, may have an outer diameter disposed to be parallel with the outermost portions of the front edge parts 130.

Furthermore, the dummy core 150 may have a continuous ring shape so as to reduce cogging torque generated in a relationship between the stator core 100 having a discontinuous ring shape and the magnet 330 having a continuous ring shape.

In addition, the dummy core 150 may be press-fitted into the base 230 or be bonded thereto by an adhesive. In this case, the base 230 may be provided with a step portion to allow the dummy core 150 to be press-fitted thereinto and may have an ‘L’ shaped cross-section in order to improve bonding adhesion through the adhesive.

The dummy core 150 is formed in such a manner that an upper edge thereof in the axial direction is disposed upwardly to face the magnet 330, such that the upper edge thereof is positioned beneath the stator core 100. When the dummy core 150 contacts the stator core 100, a reduction efficiency of the cogging torque may be reduced. Therefore, the dummy core 150 may be allowed not to contact the stator core 100.

In addition, the dummy core 150 may be made of a metal material interacting with the magnet since the dummy core 150 needs to partially interact with the magnet 330.

A description associated with the reduction of cogging torque due to the dummy core 150 according to the embodiment of the present invention will be provided in detail below with reference to FIG. 4.

The rotating member 300 may include the shaft 310 and the hub 320 including the magnet 330, and include all components that rotate while being supported by the fixed member 200.

First, the shaft 310 may be inserted into the shaft hole of the sleeve 210 so as to have a micro clearance therebetween to thereby rotate in the sleeve 210, and may include the hub 320 coupled to an upper portion thereof.

The hub 320 may be a rotating structure rotatably provided with respect to the fixed member 200 including the base 230 and include the magnet 330 having an annular ring shape and provided on an inner peripheral surface thereof, the magnet 330 corresponding to the core 100 having the coil 220 wound therearound, while having a predetermined interval therebetween.

Therefore, in the motor 10, according to the embodiment of the present invention, when external power is applied to the coil 220 wound around the core 100, the rotating member 300 rotates by rotational driving force due to electromagnetic interaction between the coil 220 and the magnet 330 included in the hub 320.

FIG. 4 is a schematic cut-away perspective view showing a disposition relationship between the stator core according to the embodiment of the present invention, a dummy core, and a magnet.

Referring to FIG. 4, the stator core 100 according to the embodiment of the present invention may include the dummy core 150 provided on the lower portion thereof, and the magnet 330 may be provided to correspond to the stator core 100 in such a manner as to enclose an outer side of the stator core 100 in the outer diameter direction.

Here, a case in which nine front edge parts 130 are provided at the outermost portion of the stator core 100 is exemplified, and outermost surfaces of the front edge parts may have a round shape but have a circumference shape corresponding to a circle having a diameter smaller than that of the magnet 330, rather than a circle concentric with the magnet 330. Further, a shape in which the magnet 330 is magnetized to have twelve poles is exemplified. Since the cases in which nine front edge parts 130 are provided or the magnet 330 is magnetized to have twelve poles are described by way of example, various modifications may also be made.

Since the outermost portions of the front edge parts 130 may be not concentric with the magnet 330 as described above, a difference is generated in magnetic force in which each of the outermost surfaces of the front edge parts 130 interact with the magnet 330, such that the rotating member having the magnet 330 mounted therein rotates based on the fixed member having the stator core 100 mounted therein.

Hereinafter, the electromagnetic noise (hereinafter, referred to as noise) due to the cogging torque will be described in detail, and a role of the dummy core 150 will be then described.

Descriptions Regarding Noise Generated by the Sataor Core

Nine teeth parts 120 may be formed in the stator core 100. Therefore, nine intervals may also be formed between the front edge parts 130.

Accordingly, a change in magnetic attractive force acting between the magnet and the core 100, that is, cogging torque, is generated during the rotation of the hub 320 including the magnet, and noise and vibrations are generated due thereto.

In other words, when the magnet rotates once around the stator core 100 including nine teeth parts 120, noise caused by strength and weakness of the magnetic attractive force generated by the intervals between the front edge parts 130 may be generated nine times.

Further, the motor 10, according to the embodiment of the present invention, may rotate at 5400 revolutions per minute (rpm), meaning there are 90 rotations per second. Therefore, when the motor 10 has a speed of 5400 rpm, a frequency may be 90 Hz.

Therefore, an amount of noise generated per second, when the magnet rotates around the stator core 100 including the nine teeth parts 120 is 9*90, which means that a generation period of the noise is

$$\frac{1}{9 * 90}$$

sec.

In other words, a noise peak is generated at a frequency corresponding to 9x Hz (x indicates a frequency according to rotations of the motor 10 per second according to the embodiment of the present invention) by the stator core 100 including the nine teeth parts 120.

Descriptions Regarding Noise Generated by the Magnet

Further, in the motor 10 according to the embodiment of the present invention, the noise peak is also generated in a frequency band of 12x Hz, which is associated with the number of magnetized poles of the magnet 330 coupled to the hub 320.

In other words, in the motor 10 according to the embodiment of the present invention, the number of magnetic poles of the magnet 330 may be twelve, and noise is generated twelve times when the magnet 330 rotates once around the stator core, due to an imbalance in magnetic pole intensity of the magnet 330.

This noise is caused by the strength and weakness of the magnetic attractive force between the magnet 330 and the stator core due to the imbalance in the magnetic pole intensity of the magnet 330. Noise generation number per second is 12*90, regardless of the core, which means that a generation period of the noise is

$$\frac{1}{12 * 90}$$

sec.

In other words, it means that the peak noise is generated at a frequency corresponding to 12x Hz (x indicates a frequency according to rotations of the motor 10 per second according to the embodiment of the present invention) by the magnet 330 magnetized to have twelve poles.

Descriptions Regarding Noise Generated by a Combination the Sataor Core and the Magnet

Finally, in the motor 10 according to the embodiment of the present invention, the electromagnetic noise due to cogging torque may be generated by a combination of the core 110 and the magnet 330 described above at the time of the rotation of the rotating member 300.

In other words, when the number of magnetic poles of the magnet 330 is twelve and the intervals between the front edge parts 130 are nine, the amount of noise generated when the magnet 330 rotates once around the core 100 may be determined by the least common multiple between 12 and 9.

That is, since the least common multiple between 12 and 9 is 36, the amount of noise generated when the magnet 330 rotates once around the core 100 is 36. Therefore, since the frequency of the motor 10 according to the embodiment of the present invention is 90 Hz, a generation period of the noise may be

$$\frac{1}{36 * 90}$$

sec.

In other words, a noise peak is generated at a frequency corresponding to 36x Hz (x indicates a frequency according to rotations of the motor 10 per second, according to the embodiment of the present invention) by the core 100 including the nine teeth parts 120 and the magnet 330 magnetized to have twelve poles.

Here, the noise at 36x HZ is prominent discrete tone (PDT) noise, referring to sensory noise which may be harsh to the ear of users, since noise in a specific frequency band is more prominent than noise in an adjacent frequency.

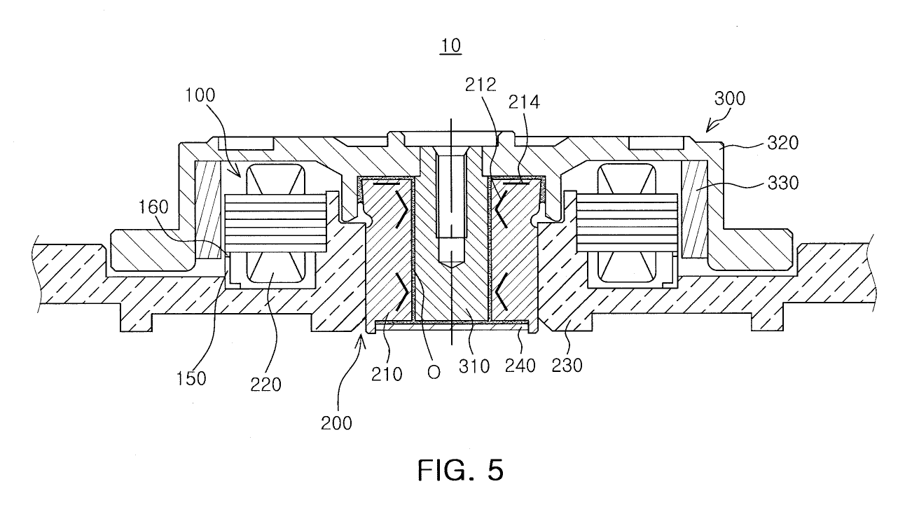

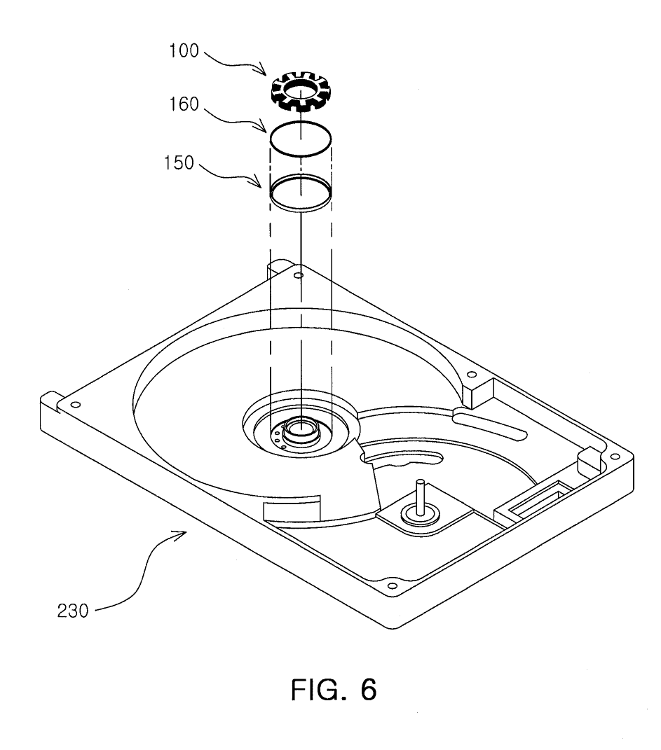

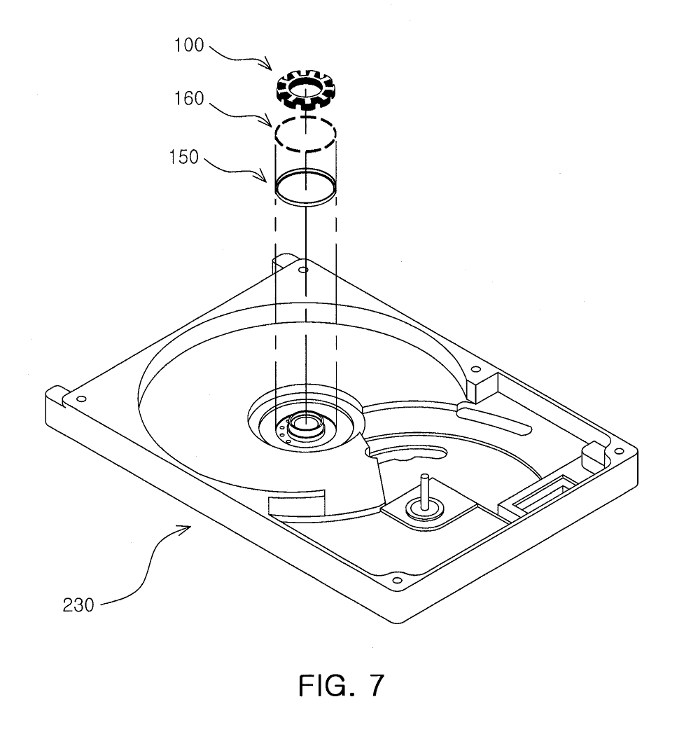

FIG. 5 is a schematic cross-sectional view showing a motor including a stator core according to another embodiment of the present invention; FIG. 6 is a schematic exploded perspective view showing a coupling relationship between the stator core according to another embodiment of the present invention, a dummy core, and a base; and FIG. 7 is a schematic exploded perspective view showing a coupling relationship between a stator core according to another embodiment of the present invention, a dummy core, and a base.

Referring to FIG. 5, the motor shown in FIG. 5 is different from the motor according to the foregoing embodiment shown in FIG. 1 in that a spacing sheet 160 is interposed between the stator core 100 and the dummy core 150. Since a configuration is the same as the configuration of FIG. 1 with the exception of the above-mentioned difference, a description thereof will be omitted.

The spacing sheet 160 is interposed between the stator core 100 and the dummy core 150 to allow the stator core 100 and the dummy core 150 to be spaced apart from each other, thereby preventing the stator core 100 and the dummy core 150 from being electromagnetically connected to each other. When the stator core 100 and the dummy core 150 are electromagnetically connected to each other, an effect generated due to the dummy core 150 is reduced. Therefore, the stator core 100 and the dummy core 150 may be allowed not to be electromagnetically connected each other in order to maximize efficiency. To this end, the spacing sheet 160 serving as a spacer is provided.

Therefore, the spacing sheet 160 needs to be formed of a non-conductive material or a non-magnetic material that does not conduct electricity or magnetism. The spacing sheet 160 may be formed of any material that does not conduct electricity or magnetism, such as rubber, silicon, plastic, or the like.

Referring to FIG. 6, the spacing sheet 160 may have a continuous ring shape so as to be interposed between the stator core 100 and the dummy core 150.

Alternatively, referring to FIG. 7, the spacing sheet 160 may be interposed between each of the front edge parts 130 of the stator core 100 and the dummy core 150. That is, the spacing sheet 160 may be provided as a plurality of pieces.

As described above, according to the embodiment of the present invention, the motor rotates by the interaction between the stator core 100 and the magnet 330, which may also inevitably causes cogging torque.

According to the embodiment of the present invention, the dummy core 150 is additionally provided to alleviate the generation of the cogging torque. That is, the dummy core 150 provided on the upper portion or the lower portion of the stator core 100 is formed to have the continuous shape in order to supplement the discontinuous shape of the stator core 100, whereby the generation of the cogging torque may be reduced.

Through the above-mentioned embodiments, cogging torque is reduced at the time of the rotation of the rotating member including the shaft 310 and the hub 320, whereby electromagnetic noise and vibrations may be reduced.

As set forth above, with the stator core and the motor including the same according to embodiments of the present invention, cogging torque is reduced at the time of the rotation of the rotating member, whereby electromagnetic noise and vibrations may be reduced.

In addition, the dummy core is additionally provided without changing a shape of the stator core necessarily provided for rotating the motor to reduce the cogging torque, whereby the noise and vibrations may be reduced by a simple additional component.

While the present invention has been shown and described in connection with the embodiments, it will be apparent to those skilled in the art that modifications and variations can be made without departing from the spirit and scope of the invention as defined by the appended claims.

What is claimed is:

1. A base assembly for a motor, the base assembly comprising:
a base member having a shaft system of the motor, disposed therein;
a stator core mounted on the base member, provided to correspond to a magnet provided in a rotating member of the motor, and having a coil wound therearound, the coil generating electromagnetic force; and
a dummy core coupled to the base member so as to be positioned on a lower portion of the stator core to thereby reduce cogging torque.

2. The base assembly of claim 1, wherein the dummy core has a ring shape.

3. The base assembly of claim 1, wherein the dummy core has an outer diameter disposed to be parallel with an outer diameter of the stator core.

4. The base assembly of claim 1, wherein the dummy core is formed such that an upper edge thereof in an axial direction is disposed upwardly to face the magnet.

5. The base assembly of claim 1, wherein the dummy core is formed of a metallic material.

6. The base assembly of claim 1, further comprising a spacing sheet interposed between the dummy core and the stator core.

7. The base assembly of claim 6, wherein the spacing sheet has a continuous ring shape.

8. The base assembly of claim 6, wherein the spacing sheet is interposed between each of front edge parts of the stator core and the dummy core.

9. A motor comprising the base assembly of claim 1.
